(19) United States
(12) Patent Application Publication
(10) Pub. No.: US 2003/0116286 A1
(43) Pub. Date: Jun. 26, 2003

(54) Apparatus and method for removing volatile components from viscous liquids

(75) Inventors: Peter R. Cowley, Lunenburg, MA (US); Randolph E. Newman, Belchertown, MA (US)

Correspondence Address: Arthur F. Dionne, Esq., McCormick, Paulding & Huber LLP, 185 Asylum Street, City Place II, Hartford, CT, 06103, US

(73) Assignee: PROCESS DEVELOPMENT SERVICES, INC., Lunenburg, MA

(21) Appl. No.: 10/320,976

(22) Filed: Dec. 17, 2002

Related U.S. Application Data
(60) Provisional application No. 60/342,665, filed on Dec. 20, 2001.

(51) Int. Cl. B01D 3/06; B01D 3/10

(52) U.S. Cl. 159/2.1; 159/28.6; 159/43.1; 159/44; 159/47.1; 159/901; 159/DIG. 16; 203/88; 203/91; 203/98; 203/2; 528/501; 528/503; 210/737; 210/750

(57) ABSTRACT

The present invention relates to an improved falling strand devolatilizer apparatus and method for devolatilization of viscous solutions to yield viscous liquids with lower content of volatile solvents, unreacted components, and reaction byproducts. The novel apparatus utilizes a devolatilization system comprised of a single vessel with two or more liquid compartments or zones, a recirculation loop, and one or more manifold and stranding distributor assemblies to divide the viscous liquid stream into a plurality of strands for effective devolatilization. A stranded stream of solution is dropped through a first zone of the chamber and collected at the bottom, the stream is recirculated, and then dropped through a second zone of the vessel and separately collected. Devolatilization is accomplished by stranding thi falling streams to optimum parameters.

### CROSS-REFERENCE TO RELATED APPLICATIONS

This application claims the benefit under 35 U.S.C. §119(e) of prior U.S. Provisional Application No. 60/342,665 filed Dec. 20, 2001; and all of which is hereby incorporated by reference.

### STATEMENT REGARDING FEDERALLY SPONSORED RESEARCH OR DEVELOPMENT

This invention has been created without the sponsorship or funding of any federally sponsored research or development program.

### BACKGROUND OF THE INVENTION

In the manufacture of monovinyl polymers such as styrene homopolymer, elastomer modified styrene homopolymer, styrene copolymers with acrylonitrile, methacrylic acid esters, and maleic acid derivatives, both with and with out elastomeric modification and acrylic polymers, by a continuous polymerization method, it is necessary to remove a fraction of unreacted monomers, solvents, and impurities from a viscous solution feed stream composed of these volatile components and polymer. To accomplish such removal, vacuum flash devolatilization is widely practiced.

This vacuum flash devolatilization is generally completed in one or more stages involving heating and exposing the viscous polymer solution stream to reduced pressure, or vacuum, where the volatile components are vaporized and removed from the purified polymer. The vacuum exposure of the viscous stream is accomplished in two general types of liquid distribution devices. The first such distributor device relies on pressure generation in upstream equipment to force the viscous stream through a manifold and thence through a plurality of flow channels which may take a variety of shapes, the intent of which is to maximize the surface area of viscous liquid to reduced pressure, and will be referred to herein as a Pressurized Distributor. The second such device relies on gravity to distribute the viscous stream over and/or through it to form one or more streams. This second device may be an open pipe discharge; or discharge over one or more flat or tilted plates, shaped plates, sieve plates or assemblies, slotted plates or assemblies; or a combination of the previously named plates or assemblies with weirs that serve to add residence time, and will be referred to herein as a Gravity Distributor.

Some practitioners use only one heating step for all stages, while others use a heating step before each distribution and vacuum exposition stage.

The incorporation of a small fraction of highly volatile stripping agent such as steam or methanol between stages is sometimes practiced.

Gordon et al. in U.S. Pat. No. 3,853,672 Dec. 10, 1974 disclose the apparatus for an improved falling strand devolatilizer comprised of a shell and tube heat exchanger whose tubes discharge as falling strands into a vessel operating under a level of vacuum provided by a gas pump attached to the first vessel. Said first vessel is connected to a second vessel that operates at a higher degree of vacuum via an actuated valve that controls the flow from and level in the first vessel. The claims include a liquid pump to empty the second vessel, a level sensor in the first vessel and a level controller. The claims also are limited to vessels with generally tapering lower regions terminating in a discharge port.

Hagberg in U.S. Pat. No. 3,928,300 Dec. 23, 1975 discloses a process for devolatilizing polystyrene in essentially the same device disclosed by the Gordon patent above. Hagberg claims a process for devolatilizing of styrene homopolymer that minimizes the oligomer content in said styrene homopolymer by exposing the tubes of the shell and tube heat exchanger to various levels of vacuum in the first flash chamber and passing the polymer solution by gravity and differential pressure to the second flash vessel that operates at a fixed higher level of vacuum. Hagberg shows a reduction of styrene oligomer content in the product from 1.7% to 1.2% by adjusting the first flash vessel pressure from 760 to 50 mm. HG absolute.

Hagberg U.S. Pat. No. 3,966,538 Jan. 29, 1976 discloses the apparatus for the Hagberg patent above which is essentially the same as the Gordon patent, differing only in modifying the method of attachment of said heat exchanger to insert the discharge tubesheet into the said first vessel. The patent also claims the embodiment of this heat exchanger and vessel combination where the second flash vessel is not used.

Newman in U.S. Pat. No. 4,294,652 Oct. 13, 1981 discloses an improvement to the apparatus of the aforedescribed Gordon and Hagberg equipment. The improvement is the partition of the second flash vaporization tank into two compartments with a means of circulating from one side to the other. A baffle is used to divert the flow to one compartment and a weir is used to separate the tank bottom into two compartments of substantially equal size. The circulated material may be transferred through an orifice to increase the surface area of said falling material during devolatilization.

These four aforementioned patents have in common the design whereby the material enters the first flash vessel through a heat exchanger whose tubes discharge viscous liquid directly as partially devolatilized falling strands into said first flash vessel. Further, the material passes from the first vessel by gravity and differential pressure through a valve into a second flash vessel, which is maintained at a higher vacuum relative to the first vessel. In the last disclosed improvement of said design, the second flash vessel is modified by addition of a baffle, weir and recirculation loop to subdivide said second flash vessel into two compartments of substantially equal size.

McCurdy, et al. in U.S. Pat. No. 4,439,601 Mar. 27, 1984 discloses a multistage devolatilization process and apparatus for use therein that comprises a heater followed by two flash vessels operating at less than atmospheric pressure. The second flash vessel operates at a pressure below the first flash vessel. The vapors removed from the second flash vessel are recombined with the vapor from the first flash vessel. The arrangement of the heat exchanger and the first flash vessel is not specified. The method in which the material passes from the first flash vessel into the second flash vessel is not specified. Nor is the means for allowing the recombining of vapor from the first and second flash vessels specified. This aforementioned equipment can be operated with or without heating between the first and second flash vessels. The use of a third flash vessel is provisionally claimed. The main intent of McCurdy is to allow condensation of all removed vapor by means of normal cooling water rather than by means of refrigerated water, thereby saving operational costs.

Ando, et al. in U.S. Pat. No. 4,537,954 Aug. 27, 1985 discloses a three stage devolatilization process for removing volatile components. Each stage is specified as consisting of a vertical foaming preheater and one vacuum vessel. The third stage is operated at a pressure of 50 Torr or less in the presence of a highly volatile foaming agent.

Morita, et al. in U.S. Pat. No. 5,024,728 Jun. 18, 1991 discloses the method and apparatus for devolatilizing polymer consisting of a vertical downward flowing multiple tube heat exchanger that subdivides the polymer and vapor stream from each tube into a plurality of streams by means of an apertured distributor mounted directly on each tube of said heat exchanger, said apertures discharging directly into a flash vessel (first volatilization zone.) A variety of aperture designs is detailed.

Sosa, et al. in U.S. Pat. No. 5,540,813 Jul. 30, 1996 discloses the apparatus and process for a monovinyl aromatic polymer devolatilization that utilizes two product stream heaters followed by two-flash vessels (vacuum devolatilizers). The first flash vessel is shown receiving the product stream from a vertical down-flow heat exchanger with the tubes discharging individually into said flash vessel as in the group of patents summarized above (Gordon, Hagberg, Hagberg and Newman). The second flash vessel is operated at a higher vacuum than said first flash vessel and receives the product stream through a manifold containing a plurality of polymer ejection nozzles whereby the stream flows in strands of less than about 5/32 inch diameter.

All of the above systems have drawbacks and limitations. In some cases, the limitations relate to the degree of devolatilization that can be accomplished with a specific system or piece of equipment. In other cases, the limitations relate to the kinds of liquid that can be effectively devolatilized with a specific system or piece of equipment.

These and other difficulties experienced with the prior art systems have been obviated in a novel manner by the present invention.

It is, therefore, an outstanding object of the present invention to provide apparatus and methods that increase the ability and effectiveness of a piece of equipment or system to devolatilize a liquid stream.

Another object of this invention is to provide apparatus and methods that reduce the equipment space required to effectively devolatilize a liquid stream.

A further object of the present invention is to provide apparatus and methods that increase the range of kinds and physical properties of liquid streams that a piece of equipment or system can effectively devolatilize.

It is another object of the invention is to provide apparatus and methods that can retrofit existing equipment or systems to increase the ability and effectiveness of the equipment or system to devolatilize a liquid stream.

It is a further object of the invention to provide a devolatilization system which is capable of being manufactured of high quality and at a low cost, and which is capable of providing a long and useful life with a minimum of maintenance.

With these and other objects in view, as will be apparent to those skilled in the art, the invention resides in the combination of parts set forth in the specification and covered by the claims appended hereto, it being understood that changes in the precise embodiment of the invention herein disclosed may be made within the scope of what is claimed without departing from the spirit of the invention.

### BRIEF SUMMARY OF THE INVENTION

It has now been discovered that further improvements in the falling strand devolatilizer can be achieved by utilizing a single vessel for two vacuum flash stages by separating the bottom of said vessel into at least two compartments without utilizing a baffle in the upper section to divert flow, and by distributing the polymer melt recirculating from the first compartment through a manifold to create strands of polymer falling through the second compartment.

It has been further discovered that this type of apparatus may be used to devolatilize not only the previously named polymers, but also a variety of viscous liquid solutions. Viscous liquids are characterized by their property of flowing in the laminar flow regime, which is well-defined in the Chemical Engineering field as the regime in which a fluid flows at a Reynolds number of less than 2,100. References to “viscous liquid” herein therefore refer to a variety of polymer and non-polymer liquids, which characteristically flow in the laminar regime.

It has been further discovered that a viscous solution may be fed to the apparatus from a heat exchanger tubesheet, or from a pipe that allows the feed solution to flow on or through a Gravity Distributor or a Pressurized Distributor.

The inventors conducted extensive research and investigations into improving the apparatus employed to separate non-volatile and volatile constituents of a viscous liquid stream in a continuous unit operation. They have discovered that the objective of minimizing the volatile components in the product stream can best be achieved by utilizing an apparatus that maximizes the surface area exposure of viscous liquid to a vacuum, vaporizing the volatile components and removing them from the viscous liquid.

The apparatus consists of a vessel and components that receive the viscous liquid stream containing volatile components in the upper portion of said vessel, and expose the viscous liquid stream to a high level of vacuum via either a Pressurized or Gravity Distributor while passing the material to bottom of said vessel. Further, the partially devolatilized viscous liquid is collected in the bottom, where baffles are used to partition the bottom into at least two compartments, and transferred by means of a pumping device back to the upper portion of said vessel, where a manifold system that contains a number of flow channels directs the recirculated viscous liquid stream as strands back to the bottom of said vessel, thereby exposing said strands to said high level of vacuum. In addition, said flow channels are arranged in such a manner as to direct the recirculated viscous liquid stream to the opposite side of the baffles from whence it was recirculated. The vaporized volatile components are removed via vapor takeoff ports to the vacuum source, and the remaining purified product is removed from the second set of bottom compartments to be further processed.

Examples of Further Processing are filtering, stranding, spinning, cooling, having further components added, forming into pellets, or other processing to prepare a product into its final form.

The claimed apparatus may receive its viscous liquid feed by a variety of methods, including by gravity and differential pressure from a previous reactor or vessel; from a discharge pipe from a previous reactor or vessel; or from a heat exchanger mounted on or beside the apparatus. The viscous liquid feed may be distributed on or through either a Pressurized Distributor or a Gravity Distributor.

Some embodiments of the present invention incorporate a heat exchanger in the apparatus to add heat to the recirculating viscous liquid stream.

### BRIEF DESCRIPTION OF THE DRAWINGS

The character of the invention, however, may best be understood by reference to one of its structural forms, as illustrated by the accompanying drawings, in which:

FIG. 1 is a side elevation in partial schematic and diagrammatic form of one embodiment of the present invention,

FIG. 2 is a side elevation in partial schematic and diagrammatic form of another embodiment of the present invention,

FIG. 3 is a side elevation in partial schematic and diagrammatic form of a third embodiment of the present invention, and

FIG. 4 is a side elevation in partial schematic and diagrammatic form of a fourth embodiment of the present invention.

### DETAILED DESCRIPTION OF THE INVENTION

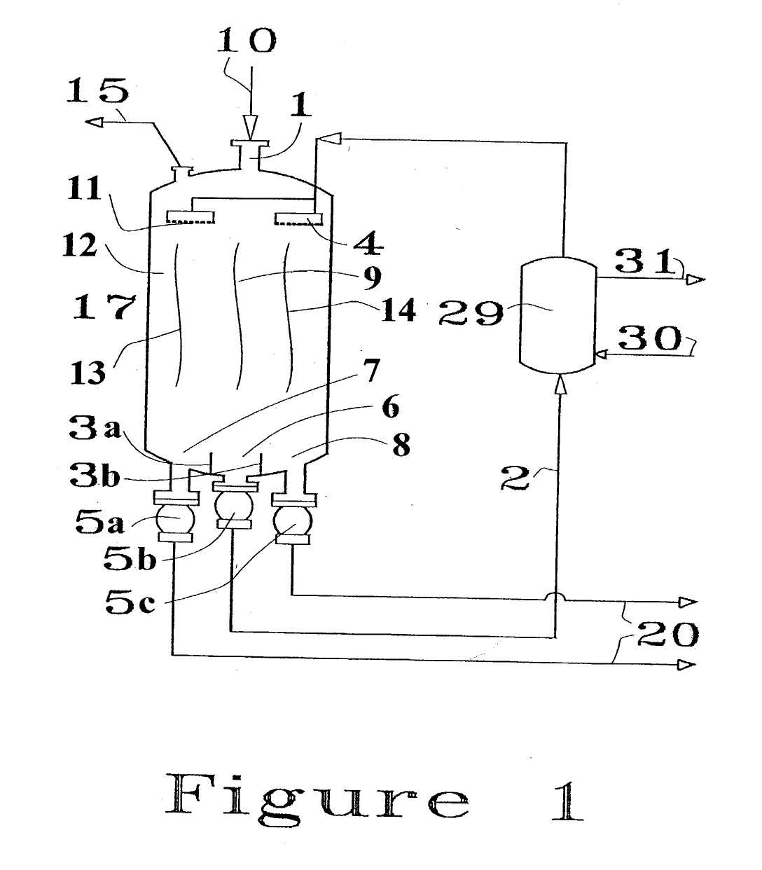

Referring to FIG. 1, there is seen illustrated one embodiment of apparatus suitable for the practice of this invention, such embodiment of the devolatilizer apparatus 12 being composed of a vacuum flash vessel 17 and a viscous solution feed nozzle 1, recirculation line 2, compartment separating baffles 3a and 3b, viscous liquid manifold and stranding distributor or Pressurized Distributor 4, pumping devices 5a, 5b, and 5c, optional recirculating viscous liquid heat exchanger 29 with its heating media inlet 30 and outlet 31, and vapor outlet nozzle 15.

Viscous solution 10 (which may have been previously partially devolatilized), containing some portion of volatiles, enters the vacuum flash vessel 17 via viscous solution feed nozzle 1. The transfer of material thereto is accomplished by gravity and differential pressure between a previous devolatilizer flash chamber or other upstream equipment and the devolatilizer apparatus 17. This viscous liquid stream 10 may pass over or through a Gravity Distributor (not shown) to assist in reducing the remaining residual volatile components. The viscous liquid first-pass stream 9 is directed to the first area of the bottom portion of vacuum flash vessel 17 where the first compartment 6, formed by separating baffles 3a and 3b, collects said first-pass viscous liquid stream 9. The first compartment 6 may be level controlled. The viscous liquid 9 thus collected in the first compartment 6 is pumped via the first pumping device 5b through the recirculation line 2 to the viscous liquid manifold or Pressurized Distributor 4. Said manifold 4 directs the viscous liquid into a number of flow channels 11 that direct the second-pass viscous liquid stream 13 and 14 through the vacuum flash vessel 17 a second time. The design of said manifold 4 is critical to the operation of the invention. First, the manifold must be designed to direct the viscous liquid strands 13 and 14 generally downward to secondary chambers 7 and 8 on the opposite side of baffles 3a and 3b from the first chamber 6 from whence it was recalculated. Secondly, the number and size of the flow channels in said manifold 4 must be such that the Pressurized Distributor channels are designed to maintain the square of the average strand hydraulic diameter times the square root of the ratio of initial strand velocity to viscous liquid viscosity less than 0.00005 in units of centimeters, grams and seconds. The viscous liquid ejected as strands from said manifold 4 is exposed a second time to high level of vacuum, thereby vaporizing further volatile components that remained in the viscous liquid after the first exposure to the same high level of vacuum. The viscous liquid strands are collected in the secondary compartments 7 and 8 of the bottom portion of said vessel, which may be level-controlled, from where said viscous liquid is pumped via the remaining pumping device(s) 5a and 5c as viscous product 20 to Further Processing. The volatile components that are vaporized in both aforementioned exposures of the viscous liquid stream to high vacuum exit the flash vessel 17 through exit vapor nozzle 15. The recirculated viscous liquid stream may be heated or cooled as it passes through the recirculation line 2 by utilizing the optional heat exchanger 29.

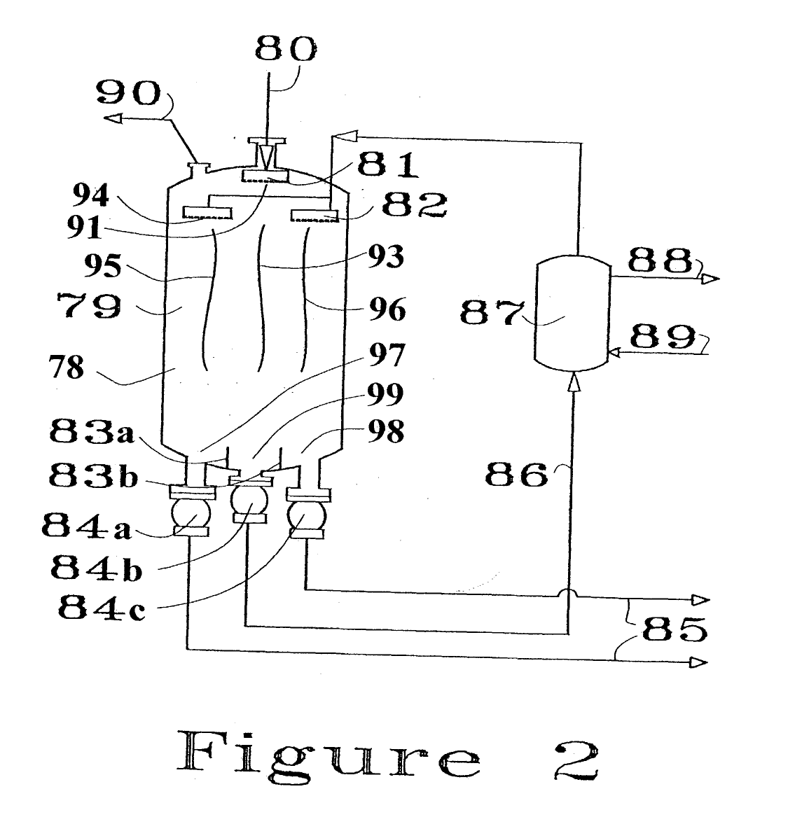

Referring to FIG. 2, there is seen illustrated another embodiment of apparatus suitable for the practice of this invention, such embodiment of the devolatilizer apparatus 78 being composed of a vacuum flash vessel 79 and a viscous solution feed nozzle with an inlet Pressurized Distributor 81, recirculation line 86, compartment separating baffles 83a and 83b, recirculation viscous liquid manifold and stranding distributor 82, pumping devices 84a, 84b, and 84c, optional recirculating viscous liquid heat exchanger 87 with its heating media inlet 89 and outlet 88, and vapor outlet nozzle 90.

Viscous solution 80 containing some portion of volatiles enters the vacuum flash vessel 79 via the inlet Pressurized Distributor 81, the transfer of material thereto being accomplished by differential pressure relative to the high vacuum maintained in the vacuum flash vessel 79, said pressure being generated by an upstream equipment, such as a pumping device (not shown). Inlet Pressurized Distributor 81 is designed in such a manner as to direct the viscous liquid into a number of flow channels 91. The number and size of said channels is of great importance to the successful operation of the devolatilizer apparatus; said first Pressurized Distributor channels are designed to maintain the square of the average strand hydraulic diameter times the square root of the ratio of initial strand velocity to viscous liquid viscosity at less than 0.0001 in units of centimeters, grams and seconds. The first-pass viscous liquid streams 93 from said channels are directed generally downward to the first area of the bottom portion of vacuum flash vessel 79 where the compartment separating baffles 83a and 83b form first compartment 99 which collects said first-pass viscous liquid stream 93. The viscous liquid 93 thus collected in the first compartment 99, which may be level-controlled, is pumped via the first pumping devices 84b, through a recirculation line 86, to the recirculation viscous liquid manifold 82. Said recirculation manifold 82 directs the viscous liquid into a number of flow channels 94 that direct the second-pass viscous liquid stream 95 and 96 through the vacuum flash vessel 79 a second time. The design of said recirculation manifold 82 is critical to the operation of the invention. First, the recirculation manifold 82 must be designed to direct the viscous liquid strands 95 and 96 generally downward to the secondary compartments 97 and 98 on opposite side of baffles 83a and 83b from the first compartment 99, from whence the stream was recirculated. Secondly, the number and size of the flow channels 94 in said recirculation manifold 82 must be such that the square of the average strand hydraulic diameter times the square root of the ratio of initial strand velocity to viscous liquid viscosity is less than 0.00005 in units of centimeters, grams and seconds. The viscous liquid ejected as strands from said recirculation manifold 82 is exposed a second time to a high level of vacuum, thereby vaporizing further volatile components that remained in the viscous liquid after the first exposure to the same high level of vacuum. The viscous liquid strands are collected in the secondary compartments 97 and 98 of the bottom portion of said vessel, which may be level-controlled, from where said viscous liquid is pumped via the remaining pumping devices 84a and 84b as viscous product 85 to Further Processing. The volatile components that are vaporized in both aforementioned exposures of the viscous liquid stream to high vacuum exit the vacuum flash vessel through exit vapor nozzle 90. The recirculated viscous liquid stream may be heated or cooled as it passes through the recirculation line 86 by utilizing the optional heat exchanger 87.

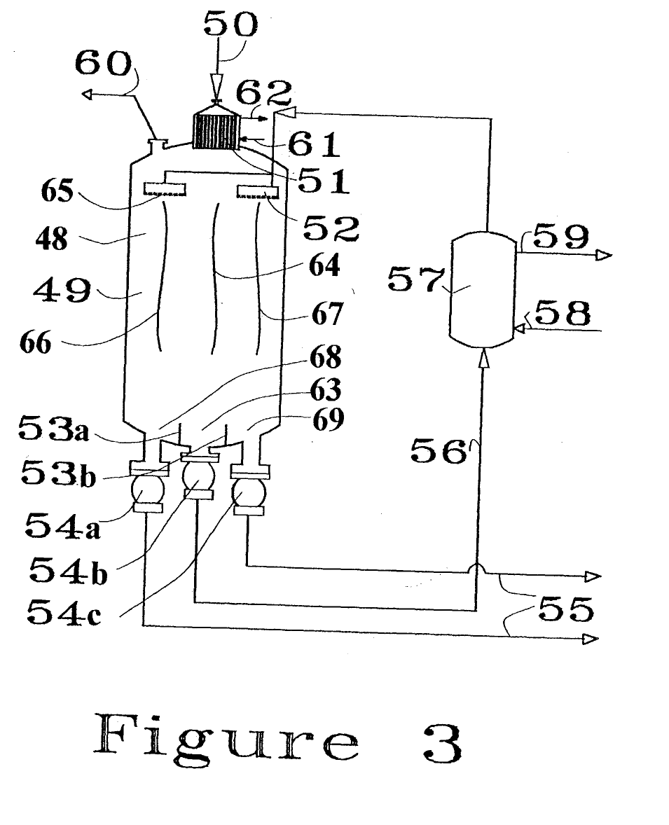

Referring to FIG. 3, there is seen illustrated another embodiment of apparatus suitable for the practice of this invention, such embodiment of the devolatilizer apparatus 48 being composed of a vacuum flash vessel 49 and inlet or feed heater 51 with its heating media streams 61 and 62, recirculation line 56, compartment separating baffles 53a and 53b, recirculation viscous liquid manifold and stranding distributor 52, pumping devices 54a, 54b, and 54c, optional recirculating viscous liquid heat exchanger 57 with its heating media inlet 58 and outlet 59, and vapor outlet nozzle 60.

Viscous solution 50 containing some portion of volatiles enters the devolatilizer vessel 49 via inlet heat exchanger 51, the transfer of material thereto being accomplished by means of upstream equipment such as a pumping device (not shown). The inlet heat exchanger 51 can be of various designs—vertical down-flow shell and tube, with or without mixing elements, discharging directly from the tubes into the vessel; vertical up-flow shell and tube, with or without mixing elements, discharging into the vessel from a pipe or modified pipe; or a radial flow stacked plate heater, the design of which will be known to those practiced in the art. All inlet heat exchanger 51 designs have the common elements of large surface areas and minimized restrictions to discharge flow between the heated surfaces and the vacuum flash vessel 49. Partially devolatilized viscous liquid exits the heat exchanger and may pass over or through a Gravity Distributor (not shown) to assist in reducing the remaining residual volatile components as it is directed, as first-pass stream 64, to the first area of the bottom portion of flash vessel 49 where a first compartment 63, formed by the compartment separating baffles 53a and 53b, collects said viscous liquid stream 64. The viscous liquid 64 thus collected in the first compartment 63, which may be level-controlled, is pumped via the first pumping device 54b through the recirculation line 56 to the recirculation viscous liquid manifold and stranding distributor 52. Said recirculation manifold 52 contains a number of flow channels 65 that further reduce the viscous liquid stream into strands that direct the second-pass viscous liquid stream 66 and 67 through the flash vessel 49 a second time. The design of said recirculation manifold 52 is critical to the operation of the invention. First, the manifold must be designed to direct the viscous liquid strands of second-pass stream 66 and 67 generally downward to a secondary compartment 68 and 69 on the opposite side of baffles 53a and 53b from first compartment 63, from whence the stream was recirculated. Secondly, the number and size of the flow channels in said recirculation manifold 52 must be such that the square of the average strand hydraulic diameter times the square root of the ratio of initial strand velocity to viscous liquid viscosity less than 0.00005 in units of centimeters, grams and seconds. The second-pass viscous liquid stream 66 and 67 ejected as strands from said recirculation manifold 52 is exposed a second time to high level of vacuum, thereby vaporizing further volatile components that remained in the viscous liquid after the first exposure to the same high level of vacuum. The viscous liquid strands 66 and 67 are collected in the secondary compartments 68 and 69 of the bottom portion of said vessel 49, which may be level controlled, from where said liquid is pumped via the remaining pumping devices 54a and 54C as viscous product 55 to Further Processing. The volatile components that are vaporized in both aforementioned exposure of the viscous liquid stream to high vacuum exit the vacuum flash vessel through exit vapor nozzle(s) 60. The recirculated viscous liquid stream may be heated or cooled as it passes through the recirculation line 56 by utilizing the optional heat exchanger 57.

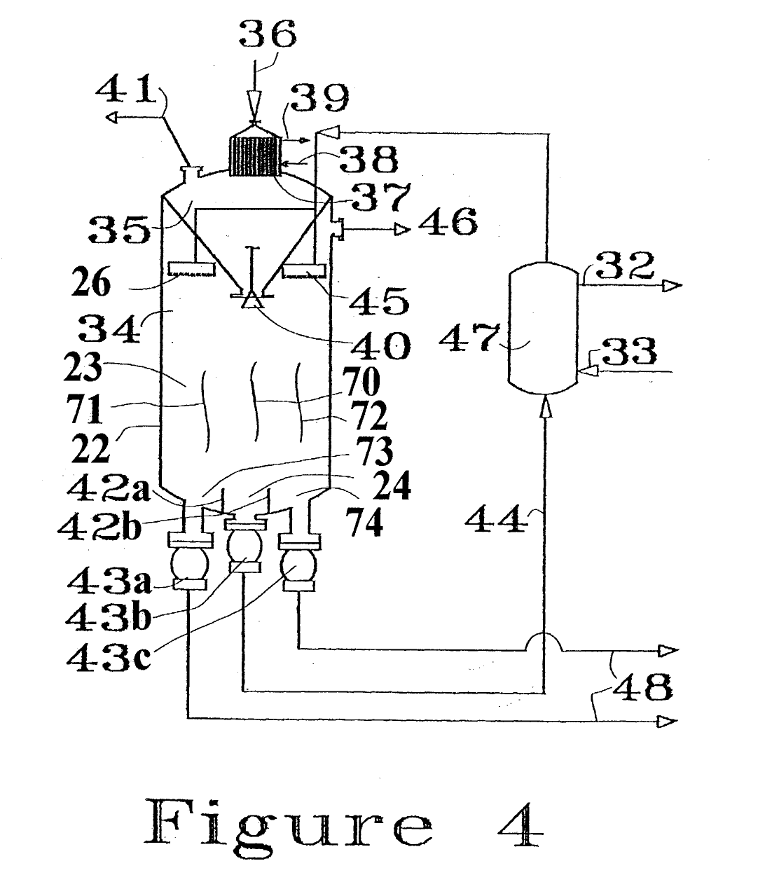

Referring to FIG. 4, there is seen illustrated another embodiment of apparatus suitable for the practice of this invention, such embodiment of the devolatilizer apparatus 22 being composed of a duplex vacuum flash vessel 34 containing an internal vacuum flash chamber 35 and inlet feed heater 37 with its heating media streams 38 and 39, recirculation line 44, compartment separating baffles 42a and 42b, a recirculation viscous liquid manifold and stranding distributor 45, pumping devices 43a, 43b, and 43c, optional recirculating viscous liquid heat exchanger 47 with its heating media inlet 33 and outlet 32, primary vapor outlet nozzle 41 and secondary vapor outlet nozzle 46.

Viscous solution 36 containing some portion of volatiles enters the flash vessel 34 and internal vacuum flash chamber 35 via inlet heat exchanger 37, the transfer of material thereto being accomplished by means of upstream equipment such as a pumping device (not shown). The inlet heat exchanger 37 can be of various designs—vertical down-flow shell and tube, with or without mixing elements, discharging directly from the tubes into the vessel; vertical up-flow shell and tube, with or without mixing elements, discharging into the vessel from a pipe or modified pipe; or a radial flow stacked plate heater, the design of which will be known to those practiced in the art. All heat exchanger 37 designs having the common elements of large surface areas and minimized restrictions to discharge flow between the heated surfaces and the vacuum flash vessel. Partially devolatilized viscous liquid exits said heat exchanger 37 and enters the internal vacuum flash chamber 35 where it is exposed to a high level of vacuum. Volatile components are vaporized from the viscous fluid and are transferred out of the internal vacuum flash chamber 35 via primary vapor outlet nozzle 41. The remaining viscous liquid is collected in the bottom of said internal vacuum flash chamber 35 from whence it flows by gravity and differential pressure through interstage valve 40 into the lower, secondary chamber 23 of vacuum flash vessel 34. Said lower chamber 23 of vessel 34 is maintained at a higher level of vacuum than maintained in the internal vacuum flash chamber 35. Partially devolatilized viscous liquid exits the interstage valve 40 and may pass over or through a Gravity Distributor (not shown) to assist in vaporizing the remaining residual volatile components as it is directed, as first pass liquid stream 70 to the first area of the bottom of the lower chamber 23 of vacuum flash vessel 34, where a first compartment 24, formed by the compartment separating baffles 42a and 42b, collects said first pass viscous liquid 70. The viscous liquid thus collected in the first compartment 24, which may be level-controlled, is pumped via the first pumping device 43b through the recirculation line 44 to the recirculation viscous liquid manifold and stranding distributor 45. Said manifold 45 contains a number of flow channels 26 that further reduce the viscous liquid stream into strands that direct the viscous liquid, as second-pass stream 71 and 72 into secondary chambers 73 and 74, separate from the first chamber 24, so that the stream 71 and 72 pass through the lower chamber 23 a second time. The design of said recirculation manifold 45 is critical to the operation of the invention. First, the recirculation manifold 45 must be designed to direct the viscous liquid strands 71 and 72 generally downward to the secondary compartments 73 and 74 on the opposite side of baffles 42a and 42b from the first compartment 24 from whence the stream was recirculated. Secondly, the number and size of the flow channels 26 in said manifold 45 must be such that the square of the average strand hydraulic diameter times the square root of the ratio of initial strand velocity to viscous liquid viscosity is less than 0.00005 in units of centimeters, grams and seconds. The viscous liquid 71 and 72 ejected as strands from said recirculation manifold 45 is exposed a second time to high level of vacuum, thereby vaporizing further volatile components that remained in the viscous liquid after the first exposure to the same high level of vacuum. The viscous liquid strands are collected in the secondary compartments 73 and 74 of the bottom portion of said vessel, which may be level-controlled, from where said viscous liquid is pumped via the remaining pumping devices 43a and 43c as viscous product 48 to Further Processing. The volatile components that are vaporized in the lower or secondary chamber 23 of said vacuum flash vessel 34 exit through secondary vapor outlet nozzle 46. The recirculated viscous liquid stream may be heated or cooled as it passes through the recirculation line 44 by utilizing the optional heat exchanger 47.

Those skilled in the art will appreciate that all of the equipment depicted in FIGS. 1 through 4 of necessity must include means of heating and insulating so as to maintain the desired viscosity of the viscous liquid. Such heating can be by means of integral fluid heating jackets, half pipe coils, external clamp on fluid heat jackets or electrical heating.

Further, those skilled in the art will recognize that the baffles, items 3a and 3b, 83a and 83b, 53a and 53b, and 42a and 42b in FIGS. 1, 2, 3, 4, respectively, can be of various shapes and dimensions so long as said baffles act to properly collect the viscous liquid falling from the upper section of the vacuum flash vessel as heretofore severally described. Those skilled in the art will also recognize that the number of pumping devices may vary from the number shown for both first and second compartments in each embodiment description.

### EXAMPLE 1

In the apparatus as presented in FIG. 2, process modeling of the apparatus where the Pressurized Distributor channels are designed to maintain the square of the average strand hydraulic diameter times the square root of the ratio of initial strand velocity to viscous liquid viscosity of 0.00004 in the first or inlet distributor (81) and 0.000013 in the second or recirculation distributor (82) in units of centimeters, grams and seconds will produce polystyrene product with residuals of 103 parts per million when fed partially devolatilized polystyrene from a previous devolatilizer operated at 225° C. and 15 millimeters of mercury absolute pressure when the recirculating melt heat exchanger (87) is operated to maintain a temperature of 255° C. and the flash vessel (79) is maintained at 2 millimeters of mercury absolute pressure.

### EXAMPLE 2

In the apparatus as presented in FIG. 4, process modeling of the apparatus where the Pressurized Distributor channels are designed to maintain the square of the average strand hydraulic diameter times the square root of the ratio of initial strand velocity to viscous liquid viscosity of 0.000005 in the recirculation pressurized distributor (45) in units of centimeters, grams and seconds will produce polystyrene product with residuals volatiles of 68 parts per million when fed polystyrene syrup containing 30% residual volatiles where the internal flash vessel (35) is maintained 80 millimeters of mercury absolute pressure, the lower portions of the flash vessel (34) are maintained at 2 millimeters of mercury absolute pressure, the feed heater (37) is operated to achieve a viscous liquid temperature in the bottom of the internal flash vessel (35) of 225° C. and the recirculating viscous liquid heat exchanger is operated to achieve a viscous liquid temperature of 255° C.

It is obvious that minor changes may be made in the form and construction of the invention without departing from the material spirit thereof. It is not, however, desired to confine the invention to the exact form herein shown and described, but it is desired to include all such as properly come within the scope claimed.

The invention having been thus described, what is claimed as new and desire to secure by Letters Patent is:

What is claimed is:

1. An improved falling strand devolatilizer apparatus comprised of:
a. A vacuum flash vessel having a top and a bottom and adapted to receive a solution consisting of viscous liquid and volatile compounds by means of differential pressure or gravity from a previous vessel,
b. A feed nozzle which is provided at the upper end of the vessel and adapted to cause the viscous solution to enter said vessel and thereafter be exposed to a high level of vacuum while the solution passes in a first stream and through a first zone from the top to the bottom of the vessel
c. A first compartment in the bottom of said vessel adapted to collect the solution in the first stream,
d. A recirculation line including at least one pumping device, said recirculating line being adapted to convey the solution collected in the first compartment from the bottom of said vessel to the top of said vessel by means of said at least one pumping device,
e. A second compartment at the bottom of said vessel and adapted to maintain its content separate from the content of the first compartment,
f. A recirculation Pressurized Distributor at the top of the vessel and designed to direct the viscous liquid from the recirculating line through a multitude of channels, through exposure to the said high level of vacuum in a second zone spaces from the first zone, and to the second compartment in the bottom of said vessel, from whence the viscous liquid is directed to further processing; and
g. An outlet nozzle adapted so that volatile compounds vaporized by the two exposures of the streams to said high level of vacuum are withdrawn from the vessel.

2. An apparatus as recited in claim 1 wherein the recirculation Pressurized Distributor channels are designed to maintain the square of the average strand hydraulic diameter times the square root of the ratio of initial strand velocity to viscous liquid viscosity at less than 0.00005 in units of centimeters, grams and seconds.

3. An apparatus as recited in claim 1 which is adapted so that the viscous solution entering the vessel passes over or through a Gravity Distributor selected from the group consisting of flat plate, tilted plate, or formed plate, sieve type and slot type Gravity Distributors, to enhance the removal of volatiles.

4. An apparatus as recited in claim 1 wherein a recirculation heat exchanger is provided in the recirculation line and the recirculation heat exchanger is adapted so that the recirculated viscous liquid stream is passed through the recirculation heat exchanger to change the temperature of the said stream.

5. An improved falling strand devolatilizer apparatus as recited in claim 1, including an inlet Pressurized Distributor wherein the viscous liquid initially entering said vessel is passed through the inlet Pressurized Distributor, said inlet Pressurized Distributor is designed in such a manner as to direct the viscous liquid into multiple flow channels, and the viscous liquid exiting said inlet Pressurized Distributor is exposed to a high level of vacuum while passing from the top to the bottom of the vessel.

6. An apparatus as recited in claim 5 wherein said inlet Pressurized Distributor channels are designed to maintain the square of the average strand hydraulic diameter times the square root of the ratio of initial strand velocity to viscous liquid viscosity at less than 0.0001 in units of centimeters, grams and seconds, and said recirculation Pressurized Distributor channels are designed to maintain the square of the average strand hydraulic diameter times the square root of the ratio of initial strand velocity to viscous liquid viscosity at less than 0.00005 in units of centimeters, grams and seconds.

7. An apparatus as recited in claim 5 wherein a recirculation heat exchanger is provided in the recirculation line and the recirculation heat exchanger is adapted so that the recirculated viscous liquid stream is passed through the recirculation heat exchanger to change the temperature of the said stream.

8. An improved falling strand devolatilizer apparatus as recited in claim 1, which includes an inlet heat exchanger mounted adjacent to the feed nozzle and adapted to change the temperature of the stream of viscous liquid that initially enters the vessel.

9. An apparatus as recited in claim 8 wherein the recirculation Pressurized Distributor channels are designed to maintain the square of the average strand hydraulic diameter times the square root of the ratio of initial strand velocity to viscous liquid viscosity at less than 0.00005 in units of centimeters, grams and seconds.

10. An apparatus as recited in claim 8 wherein the inlet heat exchanger is a shell and tube type where the bottom tube sheet mounts directly on or in said vacuum flash vessel, allowing the tubes to discharge directly into the vessel.

11. An apparatus as recited in claim 8 wherein the inlet heat exchanger is a stacked plate type mounted directly in said vacuum flash vessel, or whose outer shell is mounted on said vacuum flash vessel.

12. An apparatus as recited in claim 8 wherein the inlet heat exchanger is mounted beside said vacuum flash vessel, and the viscous liquid and volatile compounds ejected from the heat exchanger are directed through a Gravity Distributor that allows the vaporized volatile compounds to escape overhead, and the viscous liquid to fall through one or more orifices or slots, into said vacuum flash vessel.

13. An apparatus as recited in claim 8 wherein a recirculation heat exchanger is provided in the recirculation line and the recirculation heat exchanger is adapted so that the recirculated viscous liquid stream is passed through the recirculation heat exchanger to change the temperature of the said stream.

14. An improved falling strand devolatilizer apparatus as recited in claim 1, wherein the vessel includes an upper interior chamber and a separate lower interior chamber, and the vessel includes an inlet heat exchanger which includes heating channels, said upper chamber being formed by a conical or cylindrical shell containing a bottom draining nozzle fitted with a level control valve, and wherein the feed nozzle is adapted to feed the initial viscous feed solution into said inlet heat exchanger, so that the solution passes through the heating channels and discharges from them directly into an upper interior chamber of said vacuum flash vessel where the solution is exposed to a high level of vacuum, and thereafter, the viscous liquid discharges from said upper interior chamber through said level control valve by means of gravity and differential pressure, into the lower interior chamber, where it is exposed to a higher level of vacuum while dropping to the bottom of said vacuum flash vessel.

15. An apparatus as recited in claim 14 where the recirculation Pressurized Distributor channels are designed to maintain the square of the average strand hydraulic diaw.eter times the square root of the ratio of initial strand velocity to viscous liquid viscosity at less than 0.00005 in units of centimeters, grams and seconds.

16. An apparatus as recited in claim 14 wherein the viscous liquid entering the lower interior compartment passes over or through a Gravity Distributor selected from the group consisting of flat plate, tilted plate, formed plate, sieve type, and slot type Gravity Distributors to enhance the removal of volatiles.

17. An apparatus as recited in claim 14 wherein a recirculation heat exchanger is provided in the recirculation line and the recirculation heat exchanger is adapted so that the recirculated viscous liquid is passed through the heat exchanger to change of the said stream.

18. An improved method for operating a falling strand devolatilizer apparatus comprised of a vacuum flash vessel which receives a solution consisting of viscous liquid and volatile compounds by means of differential pressure or gravity from a previous vessel, said vessel having a top and a bottom, an inlet nozzle at the top of the vessel, a first compartment and a separate second compartment, both compartments at the bottom of the vessel, and a recirculation loop adapted to move liquid from the first compartment to the top of the vessel, the steps of the process comprising:
a. Causing the viscous solution to enter said vessel and to be exposed to a high level of vacuum while passing from the top to the bottom of the vessel,
b. Collecting the viscous liquid in the first compartment in the bottom of said vessel,
c. Causing the viscous liquid to be recirculated from the first compartment at the bottom of said vessel to a recirculation Pressurized Distributor in the top of said vessel by means of a pumping device in the recirculation loop,
d. Causing the liquid to pass through said recirculation Pressurized Distributor to direct the viscous liquid through a multitude of channels,
e. Causing the viscous liquid flowing from said Pressurized Distributor to be exposed to a said high level of vacuum while passing from the recirculation Pressurized Distributor to the second compartment in the bottom of said vessel, from whence the viscous liquid is pumped to further processing, and
f. Causing volatile compounds vaporized by the two exposures to said high level of vacuum to be withdrawn from the vessel through a port in the vessel.

19. A method as recited in claim 18 wherein the recirculation Pressurized Distributor channels are designed and operated to maintain the square of the average strand hydraulic diameter times the square root of the ratio of initial strand velocity to viscous liquid viscosity at less than 0.00005 in units of centimeters, grams and seconds.

20. A method as recited in claim 18 wherein as the viscous solution initially enters the vessel, it passes over or through a Gravity Distributor selected from a group consisting of flat plate, tilted plate, formed plate sieve type, and slot type Gravity Distributors to enhance the removal of volatiles.

21. A method as recited in claim 18 wherein the recirculated viscous liquid stream is passed through a heat exchanger to change the temperature of said stream.

22. A method as recited in claim 18, wherein the viscous liquid entering said vessel is passed through an inlet Pressurized Distributor, said inlet Pressurized Distributor being designed in such a manner as to direct the viscous liquid into multiple flow channels, then the viscous liquid exiting said inlet Pressurized Distributor is exposed to a high level of vacuum while passing from the top to the bottom of the vessel, and then the viscous liquid is collected in the first compartment in the bottom of said vessel.

23. A method as recited in claim 22, wherein said inlet Pressurized Distributor channels are designed to maintain the square of the average strand hydraulic diameter times the square root of the ratio of initial strand velocity to viscous liquid viscosity at less am 0.0001 in units of centimeters, grams and seconds, and said recirculation Pressurized Distributor channels are designed to maintain the square of the average strand hydraulic diameter times the square root of the ratio of initial strand velocity to viscous liquid viscosity at less than 0.00005 in units of centimeters, grams and seconds.

24. A method as recited in claim 22 wherein the recirculated viscous liquid is passed through a heat exchanger to change the temperature of the said stream.

25. A method as recited in claim 18, wherein the viscous liquid and volatile compounds that initially enter the vessel pass through an inlet heat exchanger mounted on or beside the apparatus.

26. A method as recited in claim 25 wherein the recirculation Pressurized Distributor channels are designed to maintain the square of the average strand hydraulic diameter times the square root of the ratio of initial strand velocity to viscous liquid viscosity at less than 0.00005 in units of centimeters, grams and seconds.

27. A method as recited in claim 25 wherein the inlet heat exchanger is a shell and tube type where the bottom tube sheet mounts directly on or in said vacuum flash vessel, allowing the tubes to discharge directly into the vessel.

28. A method as recited in claim 25 wherein the inlet heat exchanger is a stacked plate type mounted directly in said vacuum flash vessel, or whose outer shell is mounted on said vacuum flash vessel.

29. A method as recited in claim 25 wherein the inlet heat exchanger is mounted beside said vacuum flash vessel, and the viscous liquid and volatile compounds ejected from the heat exchanger are directed through a Gravity Distributor that allows the vaporized volatile compounds to escape overhead, and the viscous liquid to fall through one or more orifices or slots, into said vacuum flash vessel.

30. A method as recited in claim 25 wherein the recirculated viscous liquid is passed through a recirculation heat exchanger to change the temperature of the said stream.

31. A method as recited in claim 18 wherein the initial solution consisting of viscous liquid and volatile compounds is fed from a pressurized pipe from an upstream reactor or other vessel, into an inlet heat exchanger, then passes through the inlet heat exchanger heating channels, and discharges from them directly into an upper interior compartment of said vacuum flash vessel, where it is exposed to a high level of vacuum, said upper interior compartment being formed by conical or cylindrical shell containing a bottom draining nozzle fitted with a level control valve, and then the viscous liquid discharges from said upper interior compartment, through said valve by means of gravity and differential pressure, into a lower interior compartment of the vessel, where it is exposed to a higher level of vacuum while dropping to the bottom of said vacuum flash vessel.

32. A method as recited in claim 31 wherein the recirculation Pressurized Distributor channels are designed to maintain the square of the average strand hydraulic diameter times the square root of the ratio of initial strand velocity to viscous liquid viscosity at less than 0.00005 in units of centimeters, grams and seconds.

33. A method as recited in claim 31 where the viscous liquid entering the lower interior compartment passes over or through Gravity Distributor selected from a group consisting of flat plat, tilted plate, formed plate, sieve type, and slot type Gravity Distributors to enhance the removal of volatiles.

34. A method as recited in claim 31 where the recirculated viscous liquid is passed through a recirculation heat exchanger to change the temperature of the said stream.
